(19) United States
(12) Patent Application Publication
(10) Pub. No.: US 2026/0202233 A1
(43) Pub. Date: Jul. 16, 2026

(54) BLOCKAGE DETECTION APPARATUS AND A METHOD OF DETECTING THE PRESENCE OF BLOCKAGE

(71) Applicant: Logistics and Supply Chain MultiTech R&D Centre Limited, Pok Fu Lam (HK)

(72) Inventors: Chun Hung Cheng, Pok Fu Lam (HK); Ho Lam, Pok Fu Lam (HK); Shiu Kee Luk, Pok Fu Lam (HK); Cheuk Hang Lee, Pok Fu Lam (HK)

(21) Appl. No.: 19/018,009

(22) Filed: Jan. 13, 2025

(51) Int. Cl. G01F 23/80; G01F 23/292; G01F 23/296; G01F 23/30; G08C 17/02

(52) U.S. Cl. CPC G01F 23/804; G01F 23/292; G01F 23/296; G01F 23/30; G08C 17/02

(57) ABSTRACT

A blockage detection apparatus for detecting the presence of blockage including an integrated sensing module arranged to detect a plurality of parameters associated with the presence of blockage in a fluid channel; a control module arranged to process the data including the plurality of parameters received from the integrated sensing module; and a wireless communication module arranged to communicate the processed data associated with the presence of blockage in the fluid channel to a remote receiver. Disclosed also is a method of detecting the presence of blockage.

### TECHNICAL FIELD

The invention relates to a blockage detection apparatus for detecting the presence of blockage and a method of detecting the presence of blockage. More particularly, but not exclusively, the invention relates to a blockage detection apparatus for detecting the presence of blockage and a method of detecting the presence of blockage in a surface drainage system.

### BACKGROUND

Surface drainage system are canals that are created for runoff water. The surface drainage diverts or orderly removes excess water from the surface of land by improved natural surface channels or constructed drains. The drains are also supplemented by shaping and grading of the land surface when necessary.

However, debris inside U-channel and catchpit of the surface channel would affect the functionality of surface drainage system. For instance, the overflow of stormwater from drainage lines may be contributed by the blockage of drainage lines or blockage of catchpits/stormwater drains at drainage lines by landslide debris from hillside failures. Such conditions promote washout erosion on slopes which compromises the slope stability.

### SUMMARY OF THE INVENTION

In accordance with a first aspect of the present invention, there is provided a blockage detection apparatus for detecting the presence of blockage, comprising:
an integrated sensing module arranged to detect a plurality of parameters associated with the presence of blockage in a fluid channel;
a control module arranged to process the data comprising the plurality of parameters received from the integrated sensing module; and
a wireless communication module arranged to communicate the processed data associated with the presence of blockage in the fluid channel to a remote receiver.

In accordance with the first aspect, the integrated sensing module is arranged to detect the level of debris accumulated in the fluid channel.

In accordance with the first aspect, the integrated sensing module is arranged to detect the accumulated water level in the fluid channel.

In accordance with the first aspect, the integrated sensing module is arranged to detect the level of sediment or debris accumulated in a catchpit along a fluid channel.

In accordance with the first aspect, the integrated sensing module comprises a laser obstruction sensor arranged to measure the distance of the debris from the sensor.

In accordance with the first aspect, the integrated sensing module comprises a water trigger sensor with a water float sensing element being floated on the surface of the fluid in the fluid channel.

In accordance with the first aspect, the integrated sensing module comprises an ultrasonic depth sensor arranged to measure the depth of the sediment relative to the depth of the catchpit.

In accordance with the first aspect, the wireless communication module is arranged to communicate the processed data to the remote receiver in an intermittent manner within a predetermined period.

In accordance with the first aspect, the wireless communication module is configured to utilize a narrow bandwidth, low power wireless communication protocol to communicate the processed data to the remote receiver.

In accordance with the first aspect, the wireless communication module comprises a low-power, wide area network (LPWAN) module.

In accordance with the first aspect, the wireless communication protocol comprises a Long Range (LoRa) wireless communication protocol.

In accordance with the first aspect, the wireless communication module is in signal communication with a Long Range Wide-Area Network (LoRaWAN) gateway.

In accordance with the first aspect, the wireless communication module is configured to connect the control module to the remote receiver through a cellular wireless communication protocol.

In accordance with the first aspect, the wireless communication protocol comprises Narrowband Internet of things (NB-IoT).

In accordance with the first aspect, the control module comprises a low-power controller powered by a standalone power supply.

In accordance with the first aspect, the standalone power supply comprises a non-rechargeable battery.

In accordance with the first aspect, the remote receiver is arranged to receive the sensing data collected by the integrated sensing module.

In accordance with the first aspect, the control module further comprises a notification module arranged to generate an alarm when the sensing data exceeds a predetermined threshold level.

In accordance with the first aspect, the fluid channel is a U-channel of a surface channel.

In accordance with a second aspect of the present invention, there is provided a method of detecting the presence of blockage, comprising the steps of:
detecting a plurality of parameters associated with the presence of blockage in a fluid channel;
processing the data comprising the plurality of parameters associated with the presence of blockage in the fluid channel; and
transmitting the processed data associated with the presence of blockage in the fluid channel to a remote receiver.

### BRIEF DESCRIPTION OF THE DRAWINGS

Embodiments of the present invention will now be described, by way of example, with reference to the accompanying drawings in which:

FIG. 1 is a block diagram showing an embodiment of the blockage detection apparatus according to the present invention;

FIG. 2 is an enlarged view showing the isolated blockage detection apparatus of FIG. 1 in further details; and

FIG. 3 is a schematic diagram showing the workflow of a blockage detection apparatus in accordance with another example embodiment of the present invention.

### DETAILED DESCRIPTION OF THE PREFERRED EMBODIMENTS

Without wishing to be bound by theory, the inventors have discovered that there is an urgent need to monitor the clearance of U-channel and catchpit in a surface drainage system. However, the monitoring of U-channel and catchpit faces some major challenges. For instance, sensor with large size is not practical as it may become a factor in channel blockage. Small and limited space in surface channel and catchpit for installing detection sensor. All equipment, including detection sensors, would be installed and operated in outdoor, included extreme weather of environments. There is also a need of lowering the power consumption for battery supply device to increase the life span of the power supply. Frequent checking of the clearance of surface channel or catchpit is not practical for low power device which would otherwise need more than one year battery life.

The present invention provides an automated blockage detection system of surface drainage on slopes. In particular, the system utilizes multiple sensors to measure some parameters in different sections of the surface channel so as to detect the presence and magnitude of the blockage inside the surface channel. These sensors each provides information of blockage inside U-channel of surface channel, information of level of sediment or debris accumulation inside catchpit of surface channel, and information of accumulated water level inside U-channel of surface channel. These sensors are carefully selected such that the durability of the system would be suitable for outdoor and extreme weather application. As the sensors are usually located proximate to the slopes where washout erosions may happen anytime, the maintenance should be kept at a minimal effort. Thus, the battery life of the sensors should be at least 1 year and is sufficient to power up the device until it ceases to operate.

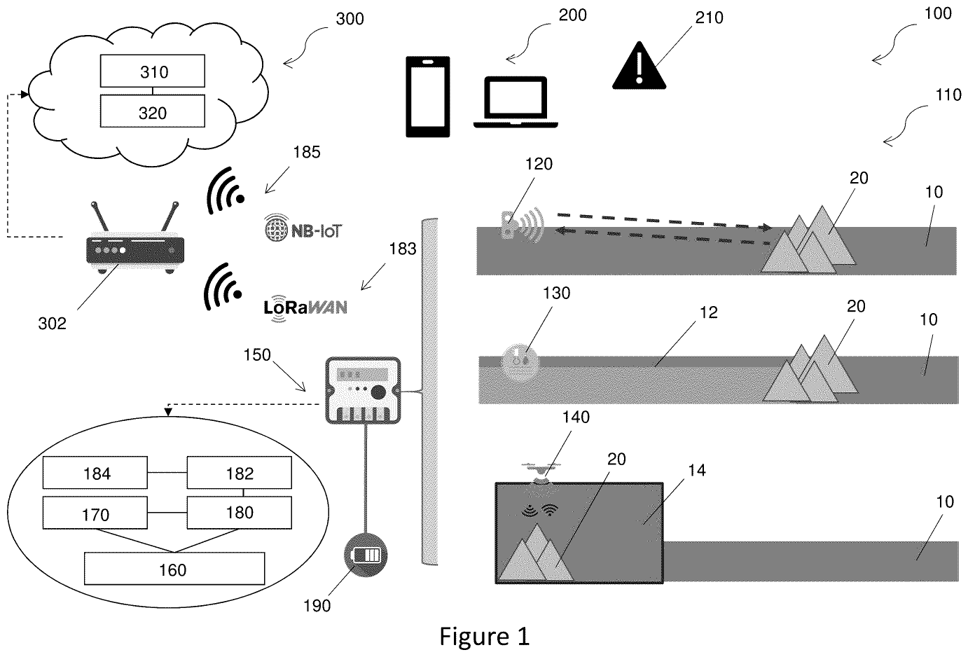

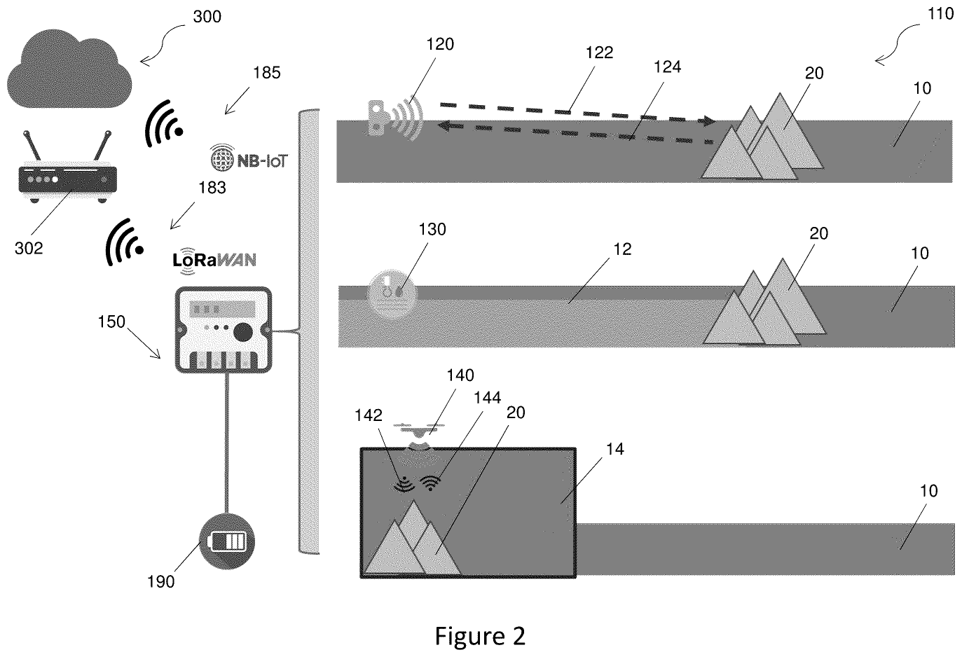

Referring to FIGS. 1 and 2, there is shown an embodiment of a blockage detection apparatus 100 for detecting the presence of blockage 20, comprising: an integrated sensing module 110 arranged to detect a plurality of parameters associated with the presence of blockage 20 in a fluid channel 10; a control module 150 arranged to process the data comprising the plurality of parameters received from the integrated sensing module 110; and a wireless communication module 180 arranged to communicate the processed data associated with the presence of blockage 20 in the fluid channel 10 to a remote receiver 300.

The present invention relates to a system and a method of remote monitoring of the clearance of a surface drainage system such as, but not limited to, U-channel 10 and catchpit 14 in the surface drainage system. Particularly, but not exclusively, the monitoring system of the present invention is adapted to determine, in real-time or near real-time, the blockage conditions at multiple locations in a surface drainage system such as the blockage inside U-channel 10 of surface channel, the level of sediment or debris accumulation inside catchpit 14 of surface channel, and accumulated water level 12 inside U-channel 10 of surface channel in order to detect, for examples, blockages or potential blockages at one or more points in the surface drainage system. This is achieved by a specific combination of internet-of-things (IoT) modules 110 and wireless communication module 180, which may comprise, but are not limited to, an integrated sensing module 110 comprising one or more sensing modules such as a laser sensor 120, a water trigger sensor 130, and/or an ultrasonic sensor 140 for detecting conditions of the blockage 20. The sensed parameters by these sensing modules 120, 130 and 140 are then reported to a control module 150.

Computer software such as computer visual and/or artificial intelligent (AI) algorithms may further be applied to process the obtained data from the sensing modules 120, 130 and 140, which significantly enhances accuracy and efficiency of the detection and the monitoring processes. The present invention further provides a computer-implemented platform, which can be web-based and/or APP-based, for remote and automated detection of blockage conditions of the surface drainage on slopes. Alerts can be generated and delivered in real-time or near real-time to warn of problems and to avoid or mitigate blockage of the surface drainage system, reducing or negating the need for manual, on-site inspections, particularly under bad weather conditions. The system is automatic, efficient and reliable.

As shown in the figures, the system 100 can be connected to one or more devices including user devices 200 such as a mobile device in the form of a smart phone or a computer device such as a tablet computer, a laptop computer, a personal computer (PC) or the like. The user devices 200 may also comprise any general or customized alarm systems 210, such as any form of audio alarm and/or visual alert systems such as an electronic notice board or display unit, etc. The computer devices 200 and/or the alarm systems 210 are provided for the user to receive alert signals from the system 100 if an unusual condition at the surface drainage system e.g., severe blockages or a potential washout erosion on slope is detected. Preferably, the user devices 200 can be configured or installed with one or more specific software or applications for receiving, displaying and/or responding to the monitored results, reports or warnings.

In one embodiment, the system 100 can be configured to connect with the computer devices 200 and/or the alarm system 210 via a communication module 180, which may include a remote network such as a cloud network 300 and/or a local network such as a local server, for transmitting data. The cloud network 300 or local server may optionally comprise a cloud database 310 for storage of data received from the various functional modules of the system 100 and an analyzing module 320 for analyzing data received from the various functional modules of the system 100. The system 100 may also include a Long Range Wide-Area Network (LoRaWAN) gateway 302 for the communication between the communication module 180 and the cloud network 300.

Preferably, the communication module 180 comprises a wireless communication module 180. The wireless communication module 180 can be implemented based on known wireless communication technologies such as but not limited to, radio frequency wireless communication executed by a radio frequency communication module 180.

More preferably, the radio frequency communication module 180 comprises a low-power, wide area network (LPWAN) module 182 for executing low-bandwidth, low power wireless communication, such as the Long Range (LoRa), low frequency communication protocol 183. The LoRA communication protocol 183 is advantageous in providing a relatively long operating range which may cover from a few kilometers in urban areas to over 10 km in rural settings. It allows effective data communication with low data rates and high sensitivities at low power and is applicable in low-connection locations such as outdoor, underground, or rural locations, e.g., forested areas, which may not be covered by or easily connectable to other wireless communication networks. The wide area network (WAN) communication is also well optimized for low power operation, such as for battery-powered devices, which is particularly useful for areas with limited or no mains power supply such as for remote, rural areas which are common locations for surface drainage system.

Additionally, the radio frequency communication module 180 may further comprise a cellular communication module 184 for implementing a cellular communication protocol 185, such as the Narrowband Internet of things (NB-IoT). The NB-IoT is advantageous in providing a narrow bandwidth, allowing for excellent extended coverage while maximizing battery life of device. The cellular communication module 185 may further be configured to implement cellular communication of other generations such as the Fourth Generation (4G) Long-Term Evolution (LTE) communication protocol and the Fifth Generation (5G) communication protocol.

Alternatively, the communication module 180 may further comprise a wired communication module preferably for wired connection with other local functional modules and/or networks.

Preferably, the system 100 may further comprise other functional blocks for performing various functions thereof. One or more of these functional blocks can be arranged in a centralized and/or decentralized configuration to implement their operations. For example, the system 100 may comprise an integrated sensing module 110 with one or more sensing modules for detecting conditions at multiple locations of the surface drainage system. While the integrated sensing module 110 can be arranged or installed at, inside or adjacent one or more U-channels 10 of the surface drainage system, the integrated sensing module 110 may also be arranged within water storage units of the drainage network such as a catchpit 14.

Referring now to FIG. 2 for a more detailed description of the integrated sensing module 110. The integrated sensing module 110 may comprise one or more sensors such as Internet-of-Things (IoT) sensors or devices. The IoT sensors 110 may include, for example, a laser sensor 120 for measuring level of debris accumulation 20 inside the U-channel 10, a water triggering sensor 130 for measuring accumulated water level 12 inside the U-channel 10, and/or an ultrasound sensor 140 for measuring the level of sediment or debris accumulation 20 inside the catchpit 14.

In one example embodiment, the laser sensor 120 can be used to monitor the level of debris accumulation 20 inside the U-channel 10 using advanced laser technology. For instance, the laser sensor 120 may send pulses of laser light 122 to the U-channel 10 and the laser lights 122 reflect off the surface of the accumulated debris 20. The laser sensor 120 then calculates the amount of time it takes for the reflection of laser lights 124 to return to the laser sensor 120. Accordingly, the measured distance may indicate the location of the blockage 20.

In one example embodiment, the water triggering sensor 130 may further include water float sensor to monitor the accumulated water level 12 inside the U-channel 10. In particular, the water triggering sensor 130 may periodically detect and monitor the presence of water level 12 at or inside the drainage network, such as at the U-channel 10, to determine any accumulated water caused by the blockage 20 within the U-channel 10. Any abnormality in the water level 12 detected may indicate occurrence of a potential blockage 20 or the like.

In one example embodiment, the ultrasound sensor 140 can be used to measure the level of sediment or debris accumulation 20 inside catchpit 14 using ultrasound waves. The ultrasound sensor 140 sends an ultrasonic pulse 142 which travels through the air and reach the catchpit 14. If there is an accumulated sediment or debris 20 inside the catchpit 14, the ultrasonic pulse 144 will bounce back to the ultrasound sensor 140. By calculating the travel time and the speed of sound, the depth of the blockage 20 can be calculated. Optionally, the ultrasound sensor 140 may be carried by a flying droid and the flying droid and send the sends the ultrasonic pulse 142 when the flying droid is flying over a flight area covering the catchpit 14.

The system 100 may further comprise a low power control module 150 powered by a power module 190 for processing the detected parameters by the sensing modules 120, 130 and 140. For instance, the data collected by the integrated sensing module 110 can be reported to the lower power controller 150 and stored at a local memory 170 of the system 100 and/or at a remote, cloud database 310 for subsequent processing by the analyzing module 320. The

data collected by these sensing modules 120, 130 and 140 may subsequently be transmitted to cloud server 300 through LoRaWAN 183 or NB-IoT 185. In one alternative example embodiment, the stored data can be used to facilitate artificial intelligent (AI) analytics for identifying possible blockage black spots, for providing big data for evaluating performance of surface drainage systems or specific regions of a surface drainage system, and/or for supporting continuous training of the AI system.

In one alternative embodiment, a portion of the sensing modules 110 can be integrated into the system 100 or may form separate functional blocks wiredly and/or wirelessly connected with other functional modules of the system 100.

The system 100 may further comprise a processor 160 comprising a processing module 160 configured to process data received from one or more of the sensing modules 120, 130 and 140 and optionally, with stored, historical data from previous detections. The previous data can be stored at the local memory 170 of the system 100 and/or the cloud database 310 located at the remote cloud network 300.

In one further example embodiment, the local cloud network 300 may comprise an analyzing module 320 for executing computer implemented algorithms such as one or more computer visual

algorithms and/or artificial intelligent (AI) machine learning algorithms for analyzing the obtained data from the integrated sensing module 110. Analysis by the analyzing module 320 is based on the real-time detected conditions of the blockage and the operating conditions at specific regions of the surface drainage system and also the historical, previously obtained data to thereby determine potential blockage of the surface drainage system.

For example, if it is detected that any one or more conditions of the blockage 20 has fallen outside of the predetermined, normal acceptable ranges set for the respective sensors 120, 130 and 140, such as below a predetermined lower threshold or above a predetermined upper threshold, the relevant data will be processed by the software and the processed results will be reported in the form of alerts instantly to the user devices 200. The analyzing module 320 is adapted to continue learning from the received data from the integrated sensing module 110 to increase accuracy for detections in the future. The system 100 is therefore useful in the prevention of incidents such as blockage and washout erosion on slopes and allows remote inspection of regions which are difficult or dangerous to physically access by service staff.

The processed results from the processor 160 will then be communicated, via the communication module 180, substantially in real-time to one or more user devices 200 which is preferably configured to issue and/or display notification information to users. Preferably, the user devices 200 can be configured or installed with one or more specific software or applications for receiving, displaying and/or responding to the monitored results, reports or warnings. In one embodiment, the received data from one or more of the integrated sensing module 110, as well as the processed data indicating or predicting conditions of the detected blockage and the drainage will be sent to a server such as the cloud server 300 and/or a local server via wireless communication, such as through a cellular network such as NB-IoT 185. The cloud server 300 may further generate in near real-time, instant alerts to one or more computer devices or smart phones 200 to report any abnormal blockage conditions or operating conditions detected in the surface drainage system, for example, the detection of a high debris level and a high water level in the U-channel 10 and/or a high level of sediment or debris inside the catchpit 14.

Preferably, the reports will further be communicated, such as via a LPWAN network 183, and more preferably, a low frequency, long range (LoRa) communication network 183 to one or more of the user devices 200, which can be provided in the form of an electronic warning sign or public notification board to show warning messages. The alerts may further be delivered via speakers for public announcement or announcement to a specific group of users. The communication via a LoRa network 183 generally requires low power which is particularly useful in remote locations where the power supply is unstable or limited. Alternatively, the reports may also be further communicated via NB-IoT 185 to one or more of the user devices 200.

In one example embodiment, the system 100 may comprise one or more standalone power modules 190 for locally powering the system 100 and one or more functional modules of the system 100. For example, the power module 190 may comprise a high-capacity non-rechargeable battery. The standalone power supply is not connected to a main power supply, but an isolated power supply dedicated to the components of the system 100 as well as the sensors 120, 130 and 140 of the integrated sensing module 110.

In one aspect of the present invention, the system 100 is configured as a device to comprise the local memory 170 for storing data and the processor 160 for executing computer readable instruction. The processor 160 is configured by the computer readable instructions, when being executed, to implement the method and the system as above described. The local memory 170 storing machine-readable instructions and the processor 160 for executing said machine-readable instructions together embody the system 100. In yet another aspect of the present invention, it is provided a non-transitory computer readable medium storing machine-readable instructions which, when implemented on a processor, implements the steps of the method as above described.

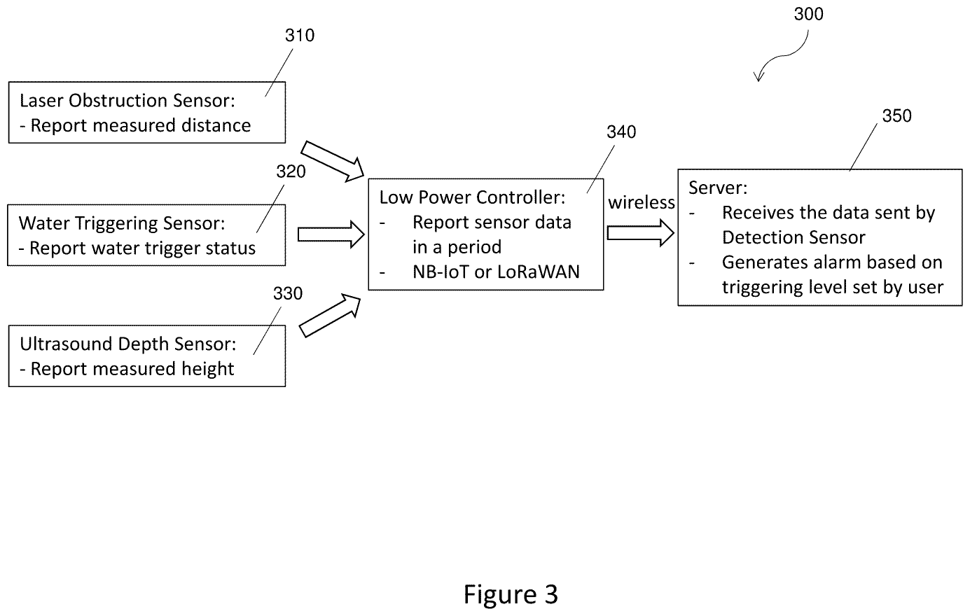

Another aspect of the invention relates to a method 300 of detecting the presence of blockage 20 will now be described with reference to FIG. 3. The method 300 comprises the steps of detecting a plurality of parameters associated with the presence of blockage 20 in a fluid channel 10; processing the data comprising the plurality of parameters associated with the presence of blockage 20 in the fluid channel 10; and transmitting the processed data associated with the presence of blockage 20 in the fluid channel 10 to a remote receiver 300.

In one example embodiment in accordance with the present invention, it begins with steps 310 to 330 and may perform steps 310 to 330 simultaneously or each in a predetermine time sequence. In step 310, the laser obstruction sensor 120 would monitor the level of debris accumulation 20 inside the U-channel 10 and report the measured distance of the accumulated debris 20 to the low power controller 150. In step 320, the water triggering Sensor 130 would monitor the accumulated water level 12 inside the U-channel 10 and report the water trigger status to the low power controller 150. In step 330, the ultrasound depth sensor 140 would measure the level of sediment or debris accumulation 20 inside catchpit 14 and report the measured height to the low power controller 150.

As the blockage 20 are gradually accumulated and the measured parameters change gradually within a certain timeframe, it is sufficient to report the measured data by the sensors 120, 130 and 140 to the low power controller 150 in a regular basis. In step 340, the low power controller 150 reports the collected sensor data periodically through LoRaWAN 183 or NB-IoT 185. In step 350, the remote server 300 would receive the data sent by the low power controller 150 and optionally generate an alarm based on triggering level set by user.

The invention has been given by way of example only, and various other modifications of and/or alterations to the described embodiment may be made by persons skilled in the art without departing from the scope of the invention as specified in the appended claims. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A blockage detection apparatus for detecting the presence of blockage, comprising:
an integrated sensing module arranged to detect a plurality of parameters associated with the presence of blockage in a fluid channel;
a control module arranged to process the data comprising the plurality of parameters received from the integrated sensing module; and
a wireless communication module arranged to communicate the processed data associated with the presence of blockage in the fluid channel to a remote receiver.

2. A blockage detection apparatus in accordance with claim 1, wherein the integrated sensing module is arranged to detect the level of debris accumulated in the fluid channel.

3. A blockage detection apparatus in accordance with claim 1, wherein the integrated sensing module is arranged to detect the accumulated water level in the fluid channel.

4. A blockage detection apparatus in accordance with claim 1, wherein the integrated sensing module is arranged to detect the level of sediment or debris accumulated in a catchpit along a fluid channel.

5. A blockage detection apparatus in accordance with claim 2, wherein the integrated sensing module comprises a laser obstruction sensor arranged to measure the distance of the debris from the sensor.

6. A blockage detection apparatus in accordance with claim 3, wherein the integrated sensing module comprises a water trigger sensor with a water float sensing element being floated on the surface of the fluid in the fluid channel.

7. A blockage detection apparatus in accordance with claim 4, wherein the integrated sensing module comprises an ultrasonic depth sensor arranged to measure the depth of the sediment relative to the depth of the catchpit.

8. A blockage detection apparatus in accordance with claim 1, wherein the wireless communication module is arranged to communicate the processed data to the remote receiver in an intermittent manner within a predetermined period.

9. A blockage detection apparatus in accordance with claim 1, wherein the wireless communication module is configured to utilize a narrow bandwidth, low power wireless communication protocol to communicate the processed data to the remote receiver.

10. A blockage detection apparatus in accordance with claim 1, wherein the wireless communication module comprises a low-power, wide area network (LPWAN) module.

11. A blockage detection apparatus in accordance with claim 9, wherein the wireless communication protocol comprises a Long Range (LoRa) wireless communication protocol.

12. A blockage detection apparatus in accordance with claim 10, wherein the wireless communication module is in signal communication with a Long Range Wide-Area Network (LoRaWAN) gateway.

13. A blockage detection apparatus in accordance with claim 10, wherein the wireless communication module is configured to connect the control module to the remote receiver through a cellular wireless communication protocol.

14. A blockage detection apparatus in accordance with claim 13, wherein the wireless communication protocol comprises Narrowband Internet of things (NB-IoT).

15. A blockage detection apparatus in accordance with claim 1, wherein the control module comprises a low-power controller powered by a standalone power supply.

16. A blockage detection apparatus in accordance with claim 15, wherein the standalone power supply comprises a non-rechargeable battery.

17. A blockage detection apparatus in accordance with claim 1, wherein the remote receiver is arranged to receive the sensing data collected by the integrated sensing module.

18. A blockage detection apparatus in accordance with claim 1, wherein the control module further comprises a notification module arranged to generate an alarm when the sensing data exceeds a predetermined threshold level.

19. A blockage detection apparatus in accordance with claim 1, wherein the fluid channel is a U-channel of a surface channel.

20. A method of detecting the presence of blockage, comprising the steps of:
detecting a plurality of parameters associated with the presence of blockage in a fluid channel;
processing the data comprising the plurality of parameters associated with the presence of blockage in the fluid channel; and
transmitting the processed data associated with the presence of blockage in the fluid channel to a remote receiver.
